(19) United States
(12) Patent Application Publication
(10) Pub. No.: US 2021/0063852 A1
(43) Pub. Date: Mar. 4, 2021

(54) PROJECTION DEVICE AND TEMPERATURE CONTROL METHOD THEREOF

(71) Applicant: Coretronic Corporation, Hsin-Chu (TW)

(72) Inventors: Jia-Hong Dai, Hsin-Chu (TW); Kun-Chieh Chan, Hsin-Chu (TW)

(73) Assignee: Coretronic Corporation, Hsin-Chu (TW)

(21) Appl. No.: 17/001,648

(22) Filed: Aug. 24, 2020

(30) Foreign Application Priority Data
Aug. 27, 2019 (CN) 201910794221.3

(51) Int. Cl. G03B 21/16

(52) U.S. Cl. CPC G03B 21/16

(57) ABSTRACT

A projection device includes a housing, a light source module, a light valve, a projection lens, and a temperature control element. The light source module is disposed in the housing and adapted to provide an illumination beam. The light valve is disposed on a transmission path of the illumination beam and configured to convert the illumination beam into an image beam. The projection lens is disposed on a transmission path of the image beam and includes a lens barrel having a curved surface. The temperature control element is disposed on the projection lens and is adapted to cool or heat the projection lens. The shape of the temperature control surface matches the curved surface of the lens barrel, and the temperature control surface is configured to be connected to the curved surface of the lens barrel. The disclosure may further provide a temperature control method of a projection device.

### CROSS-REFERENCE TO RELATED APPLICATION

This application claims the priority benefit of CHINA application serial no. 201910794221.3, filed on Aug. 27, 2019. The entirety of the above-mentioned patent application is hereby incorporated by reference herein and made a part of this specification.

### BACKGROUND

### Technical Field

The disclosure relates to an optical device and a control method thereof, and more particularly to a projection device and a temperature control method thereof.

### Description of Related Art

A projection device may be used to produce a large size image. With the evolution and innovation of technology, projection technology also continues to progress. The imaging principle of the projection device is, for example, converting an illumination beam generated by an illumination system into an image beam by a light valve, and then projecting the image beam onto a projection target (such as a screen or a wall surface) through a projection lens to form a projection image. In general, projection lenses used in projection devices may be classified into replaceable lenses and non-replaceable lenses. Non-replaceable lenses are typically used for home use and teaching purposes where projection brightness requirements are typically lower. Replaceable lenses are typically used in large outdoor scenes, exhibition halls, or large conference rooms where projection brightness requirements are typically higher.

When the brightness requirement of the projection device is increased, the lens temperature may also be increased, which may cause a reduction in the projection quality. To solve this problem, the projection lens may be heated or cooled by using an axial fan, a blower, or a cooling chip. It may be difficult to control the temperature of the cooled or heated airflow in the case of using the axial fan or the blower. Further, the cooling or heating effect of the axial fan or the blower after long-time work may not be so satisfactory. It may also be possible to use a planar cooling chip, but the planar cooling chip may be less likely to structurally conform to a cylindrical lens, and it may also be difficult to achieve a better heat transmission effect.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The disclosure provides a projection device and a temperature control method thereof. The projection device and the temperature control method may be used to effectively perform heat dissipation or heating for the projection lens, so as to improve the projection quality of the projection device.

Other objects and advantages of the disclosure may be further understood from the technical features disclosed herein.

In order to achieve one or a part or all of the above or other objects, an embodiment of the disclosure provides a projection device including a housing, a light source module, a light valve, a projection lens, and a temperature control element. The light source module is disposed in the housing and is adapted to provide an illumination beam. The light valve is disposed on a transmission path of the illumination beam and is configured to convert the illumination beam into an image beam. The projection lens is disposed on a transmission path of the image beam. The projection lens includes a lens barrel, and the lens barrel has a curved surface. The temperature control element is disposed on the projection lens and is adapted to cool or heat the projection lens, and the temperature control element has a temperature control surface. The shape of the temperature control surface matches the curved surface of the lens barrel, and the temperature control surface is configured to be connected to the curved surface of the lens barrel.

In order to achieve one or a part or all of the above or other objects, an embodiment of the disclosure provides a temperature control method of a projection device, wherein the projection device includes a projection lens, a temperature control element, and a temperature sensing element, and the projection lens includes a lens barrel having a curved surface, and the temperature control element has a temperature control surface. The shape of the temperature control surface matches the curved surface of the lens barrel, and the temperature control surface is configured to be connected to the curved surface of the lens barrel. The temperature control method includes sensing a sensed temperature of the projection device by the temperature sensing element, starting the temperature control element according to the sensed temperature, and cooling or heating the projection lens of the projection device by the temperature control element.

Based on the above, the embodiments of the disclosure have at least one of the following advantages or effects. In the projection device and the temperature control method thereof in the disclosure, the temperature control surface of the temperature control element is connected to the curved surface of the lens barrel. Therefore, the heat generated by the light beam passing through the optical elements in the projection lens may be dissipated by the temperature control surface of the temperature control element connected to the curved surface of the lens barrel, so as to achieve a better heat dissipation effect for the projection lens, thereby improving the projection quality of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2 is a schematic side view of a portion of a projection device according to an embodiment of the disclosure.

FIG. 3 is a schematic side view of the portion of the projection device of FIG. 2 in another direction.

FIG. 4 is a temperature versus time graph of a projection device according to an embodiment of the disclosure.

FIG. 5 is a temperature versus time graph of a projection device according to another embodiment of the disclosure.

FIG. 6 is a schematic side view of a portion of a projection device according to another embodiment of the disclosure.

FIG. 7 is a schematic side view of the portion of the projection device of FIG. 6 in another direction.

FIG. 8 is a flow chart showing the steps of a temperature control method of a projection device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

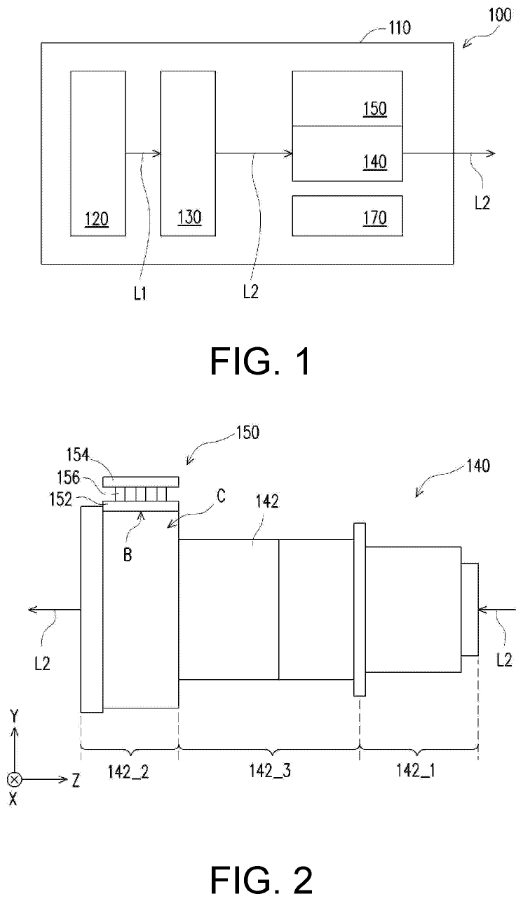

FIG. 1 is a schematic view of a projection device according to an embodiment of the disclosure. Please refer to FIG. 1. An embodiment of the disclosure provides a projection device 100, such as a projector, but the disclosure does not limit its type. The projection device 100 includes a housing 110, a light source module 120, a light valve 130, a projection lens 140, and a temperature control element 150. The light source module 120 is configured to provide an illumination beam L1 to the light valve 130. The light valve 130 is configured to receive the illumination beam L1 to generate an image beam L2. The projection lens 140 is configured to project the image beam L2 to a projection target, such as a screen, a wall or the like.

In an embodiment, the housing 110 may be an outer housing of the projection device 100 for accommodating the light source module 120, the light valve 130, at least a portion of the projection lens 140, and the temperature control element 150. The housing 110 may include an opening to allow the image beam L2 to be projected outside the projection device 100 through the projection lens 140. In this embodiment, the material of the housing 110 may be selected from plastic and metal, so as to achieve a better heat dissipation effect. However, the disclosure is not limited thereto.

In an embodiment, the light source module 120 is disposed in the housing 110 and is adapted to provide the illumination beam L1. The light source module 120 includes, for example, at least one light emitting element and may include, for example, a plurality of light emitting elements, a wavelength converting element, a light uniformizing element, a light filtering element, and a plurality of light splitting and converging elements, and the like. The light source module is configured to provide light of different wavelengths to serve as sources of the image light. The light emitting element is, for example, an ultra-high-performance lamp (UHP lamp), a light-emitting diode (LED), or a laser diode (LD). However, the disclosure does not limit the type or form of the light source module 120 in the projection device 100. The detailed structure and implementation of the light source module 120 can be sufficiently taught, suggested, and implemented by the general knowledge in the art, and therefore will not be described herein.

In an embodiment, the light valve 130 is disposed on a transmission path of the illumination beam L1 and is configured to convert the illumination beam L1 into the image beam L2. The light valve 130 includes, for example, a reflective optical modulator, such as a liquid crystal on silicon panel (LCoS panel) or a digital micro-mirror device (DMD). In some embodiments, the light valve 130 may be a transmissive optical modulator, such as a transparent liquid crystal panel, an electro-optical modulator, a magneto-optic modulator, or an acousto-optic modulator (AOM). The disclosure does not limit the form and type of the light valve 130. Regarding the method by which the light valve 130 converts the illumination beam L1 into the image beam L2, the detailed steps and implementation method thereof may be sufficiently taught, suggested, and implemented by the general knowledge in the art, and therefore may not be described herein. In the embodiment, the number of the light valves 130 is one. For example, the projection device 100 uses a single digital micro-mirror device. However, in other embodiments, the number may be plural, and the disclosure is not limited thereto.

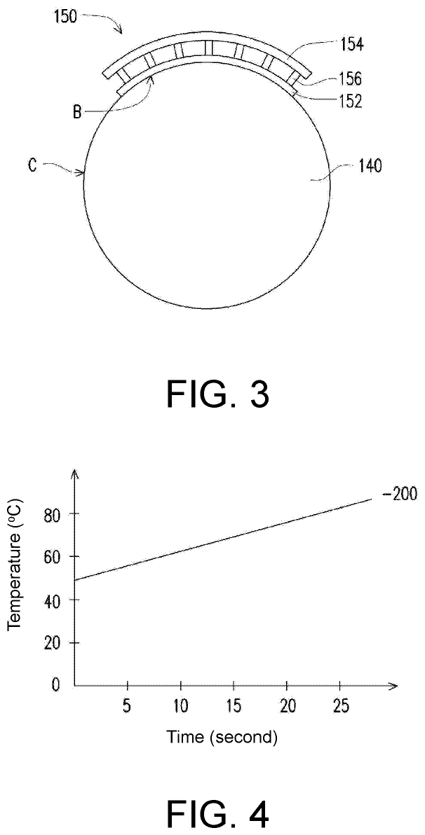

FIG. 2 is a schematic side view of a portion of a projection device according to an embodiment of the disclosure. FIG. 3 is a schematic side view of the portion of the projection device of FIG. 2 in another direction. Please refer to FIGS. 2 and 3. The projection lens 140 is disposed on a transmission path of the image beam L2. The projection lens 140 includes a lens barrel 142, and the lens barrel 142 has a curved surface C. In this embodiment, the lens barrel 142 is cylindrical and is replaceable, but the disclosure is not limited thereto. In addition, the projection lens 140 further includes a combination of one or more optical lenses with various diopter values, such as various combinations of non-planar lenses including, for example, biconcave lenses, biconvex lenses, concave-convex lenses, convex-concave lenses, plane-convex lenses, and plane-concave lenses. In an embodiment, the projection lens 140 may further include planar optical lenses to project the image beam L2 from the light valve 130 to the projection target in a reflective manner. The disclosure does not limit the form and type of the projection lens 140. In the embodiment, the lens barrel 142 includes a light incident portion 142_1 and a light exit portion 142_2 opposite to each other, and an extension portion 142_3 located between the light incident portion 142_1 and the light exit portion 142_2. In the embodiment, the light incident portion 142_1 may be closer to the light source module 120 than the light exit portion 142_2. In some embodiments, the length of the light incident portion 142_1, the light exit portion 142_2, or the extension portion 142_3 may occupy one-third to two-thirds of the total length of the lens barrel 142, respectively, but the disclosure is not limited thereto.

In an embodiment, the temperature control element 150 is disposed on the projection lens 140 and is adapted to cool or heat the projection lens 140. The temperature control element 150 may have a temperature control surface B. The shape of the temperature control surface B matches the curved surface C of the lens barrel 142, and the temperature control surface B is configured to be connected to the curved surface C of the lens barrel 142. For example, the temperature control surface B is a curved surface and may be attached to the curved surface C of the lens barrel 142. In this embodiment, the temperature control surface B of the temperature control element 150 may be attached to the curved surface C by being screwed and fastened to the lens barrel 142, but the disclosure does not limit the way in which the temperature control surface B is attached to the curved surface C of the lens barrel 142. Therefore, in the case where the shape of the temperature control surface B matches the curved surface C of the lens barrel 142, the contact area is larger, so the heat dissipation effect may be better. In this way, the heat generated by the light beam passing through the optical elements in the projection lens 140 and/or the heat generated by the light valve may be dissipated effectively by the temperature control surface B of the temperature control element 150 connected to the curved surface C of the lens barrel 142, thereby improving the projection quality of the projection device 100. In the embodiment, the temperature control element 150 is connected to the light exit portion 142_2 of the lens barrel 142. However, in different embodiments, the temperature control element 150 may be connected to the light incident portion 142_1 or the extension portion 142_3 (not shown) of the lens barrel 142 as required so as to achieve an optimal heat dissipation effect, but the disclosure is not limited thereto.

In detail, in the embodiment, the temperature control element 150 includes a first substrate 152, a second substrate 154, and a plurality of semiconductor structures 156 connected between the first substrate 152 and the second substrate 154. The first substrate 152 is in a curved shape and is connected to the curved surface C of the lens barrel 142. In other words, a surface of the first substrate 152 facing the curved surface C may sever as the temperature control surface B. In addition, in the embodiment, the second substrate 154 may also be in a curved shape, and the curvature thereof may be the same as or different from the curvature of the first substrate 152. In some embodiments, the curvature of the second substrate 154 may be different from the curvature of the first substrate 152. In a further embodiment, the second substrate 154 may be flat, but the disclosure is not limited thereto. In a further embodiment, the plurality of semiconductor structures 156 located between the first substrate 152 and the second substrate 154 may include at least two semiconductor structures extending in different directions.

In addition, in the embodiment, a negative voltage may be applied to the semiconductor structures 156, so that the first substrate 152 may serve as a cooling surface, and the second substrate 154 may serve as a heating surface, whereby the heat of the lens barrel 142 may be transmitted to the outside for effective heat dissipation. In other embodiments, a positive voltage may be applied to the semiconductor structures 156, so that the first substrate 152 may serve as a heating surface, and the second substrate 154 may serve as a cooling surface, whereby heat may be transmitted to the lens barrel 142 to heat the lens barrel 142.

FIG. 4 is a temperature versus time graph of a projection device according to an embodiment of the disclosure. Please refer to FIGS. 1 and 4. In this embodiment, the projection device 100 may further include a temperature sensing element 170 disposed in the housing 110 for sensing the temperature of the projection device 100. In the embodiment, the operation method of the temperature control element 150 of the projection device 100 may be further adjusted according to a temperature value sensed by the temperature sensing element 170. For example, in the case where a preset temperature is 40 degrees Celsius, before the projection device 100 starts the projection, if the temperature of the projection device 100 sensed by the temperature sensing element 170 is greater than or equal to 40 degrees Celsius, starting the projection device 100 in this case may be defined as a warm start, such as the line 200 shown in FIG. 4. Specifically, in the embodiment, if the projection device 100 is warm started, a negative voltage may be applied to the semiconductor structures 156 of the temperature control element 150 so that the temperature of the first substrate 152 is less than the temperature of the second substrate 154. That is, to cool the lens barrel 142, the first substrate 152 may serve as a cooling surface, and then the second substrate 154 may serve as a heating surface, so as to achieve a better projection quality. In other embodiments, the preset temperature may be other values as required, and the disclosure is not limited thereto. It should be noted that in the embodiment, although the first substrate 152 attached to the lens barrel 142 serves as a cooling surface to cool the lens barrel 142, since the projection device 100 generates heat continuously after starting the projection, the temperature sensed by the temperature sensing element 170 may increase.

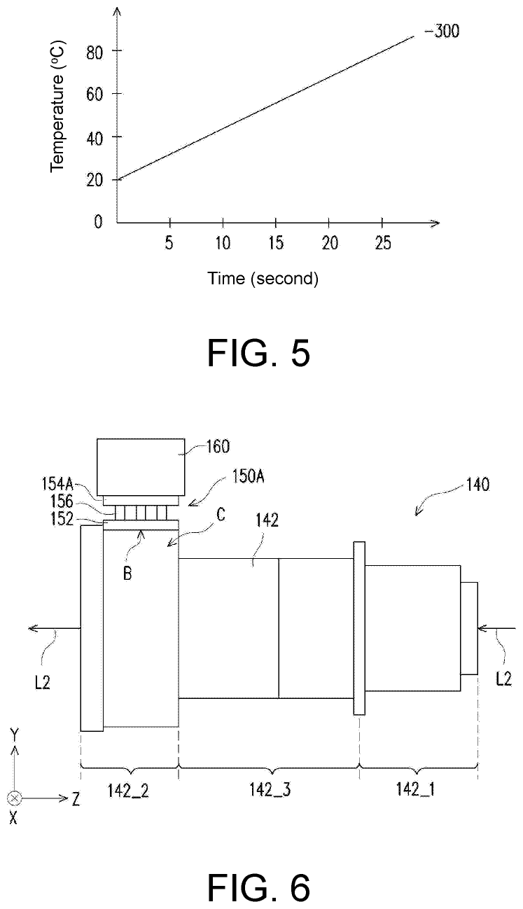

FIG. 5 is a temperature versus time graph of a projection device according to another embodiment of the disclosure. Please refer to FIGS. 1 and 5. This embodiment is similar to the embodiment of FIG. 4, and the difference between the two lies in that in this embodiment, before the start of the projection device 100, the temperature of the projection device 100 sensed by the temperature sensing element 170 is less than or equal to 40 degrees Celsius, and starting the projection device 100 in this case may be defined as a cold start, such as the line 300 shown in FIG. 5. Specifically, in the embodiment, if the projection device 100 is cold started, a positive voltage may be applied to the semiconductor structures 156 of the temperature control element 150 so that the temperature of the first substrate 152 is greater than the temperature of the second substrate 154. That is, to maintain the temperature of the projection device 100 at an appropriate operating temperature, the first substrate 152 may serve as a heating surface, and the second substrate 154 may serve as a cooling surface to heat the lens barrel 142, so as to achieve a better projection quality. It should be noted that, in comparison with the embodiment shown in FIG. 4, in this embodiment, since the first substrate 152 attached to the lens barrel 142 serves as a heating surface to heat the lens barrel 142, and since the projection device 100 generates heat continuously after starting the projection, the projection device 100 may reach a stable operating temperature more quickly. In other words, in the embodiments shown in FIGS. 4 and 5, the temperatures sensed by the temperature sensing element 170 may both increase, but the temperature rise rate of the embodiment of FIG. 5 is greater than that of FIG. 4.

In some embodiments, after the projection device 100 is started for projection, the temperature sensing element 170 may continue to be used to sense the temperature of the projection device 100 in real time, thereby obtaining a controlled temperature. A voltage value of the temperature control element 150 may be changed according to the controlled temperature. In other words, the temperature sensing element 170 is continuously used to sense the temperature of the projection device 100 in real time, and the temperature of the projection device 100 is further controlled by the temperature control element 150 to maintain the projection quality of the projection device 100.

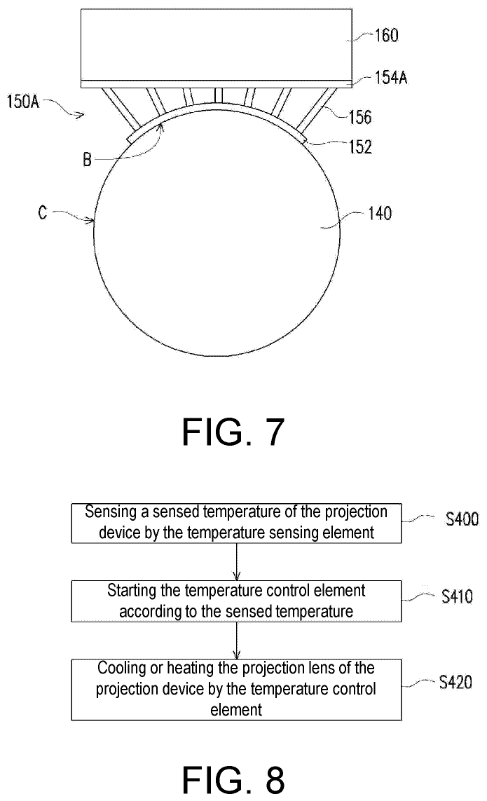

FIG. 6 is a schematic side view of a portion of a projection device according to another embodiment of the disclosure. FIG. 7 is a schematic side view of the portion of the projection device of FIG. 6 in another direction. Please refer to FIGS. 6 and 7. The temperature control element 150A of this embodiment is similar to the temperature control element 150 shown in FIG. 2, and the difference between the two lies in that in this embodiment, the curvature of the second substrate 154A of the temperature control element 150A is different from the curvature of the first substrate 152. In detail, in this embodiment, the second substrate 154A is flat, and the projection device further includes a heat dissipation module 160 connected to the second substrate 154A. The heat dissipation module 160 may include, for example, a passive heat dissipation element such as cooling fins or a heat sink, but the disclosure is not limited thereto. Moreover, the disclosure does not limit the way in which the heat dissipation module 160 is connected to the second substrate 154A. In this way, the heat dissipation or heating effect of the temperature control element 150A on the projection lens 140 may be further optimized.

FIG. 8 is a flow chart showing the steps of a temperature control method of a projection device according to an embodiment of the disclosure. Please refer to FIGS. 1, 2 and 8. The embodiment provides a temperature control method of the projection device 100, and the method may be applied to at least the projection device 100 shown in FIG. 1 and FIG. 2. Therefore, the projection device 100 shown in FIG. 1 and FIG. 2 will be taken as an example in the following description, but the disclosure is not limited thereto.

In an embodiment, step S400 is performed to sense a sensed temperature of the projection device 100 by the temperature sensing element 170. Specifically, the temperature sensing element 170 is used to sense the temperature inside the housing 110 of the projection device 100, such as the temperature at the light incident portion 142_1, the light exit portion 142_2, or the extension portion 142_3 of the lens barrel 142. Next, after step S400, step S410 may be performed to start the temperature control element 150 according to the sensed temperature. In detail, in this embodiment, the step of starting the temperature control element 150 according to the sensed temperature further includes comparing the sensed temperature with the preset temperature, and starting the temperature control element 150 according to a difference between the sensed temperature and the preset temperature to cool or heat the projection lens 140. In the embodiment, the preset temperature is, for example, 40 degrees Celsius.

Next, after step S410, step S420 may be performed to cool or heat the projection lens 140 of the projection device 100 by the temperature control element 150. Specifically, in the embodiment, the temperature control element 150 heats the projection lens 140 when the sensed temperature is less than or equal to the preset temperature. The temperature control element 150 cools the projection lens 140 when the sensed temperature is greater than or equal to the preset temperature. In some embodiments, the temperature control method of the projection device 100 further includes sensing a controlled temperature of the projection device 100 by the temperature sensing element 170, and changing a voltage value of the temperature control element 150 according to the controlled temperature. In this way, the heat generated by the light beam passing through the optical elements in the projection lens 140 and/or the heat generated by the light valve may be effectively and efficiently dissipated by the temperature control element 150 attached to the curved surface of the lens barrel 142, so that a better heat dissipation effect may be achieved, thereby improving the projection quality of the projection device 100.

In summary, the embodiments of the disclosure have at least one of the following advantages or effects. In the projection device and the temperature control method thereof in the disclosure, the temperature control surface of the temperature control element is connected to the curved surface of the lens barrel. Therefore, the projection lens may be heated or cooled by the temperature control surface of the temperature control element connected to the curved surface of the lens barrel, thereby improving the projection quality of the projection device.

However, the above are only preferred embodiments of the disclosure and are not intended to limit the scope of the disclosure; that is, all simple and equivalent changes and modifications made according to the claims and the contents of the disclosure are still within the scope of the disclosure. In addition, any of the embodiments or the claims of the disclosure are not required to achieve all of the objects or advantages or features disclosed herein. In addition, the abstract and title are used to assist in the search of patent documents and are not intended to limit the scope of the disclosure. In addition, the terms “first,” “second” and the like mentioned in the specification or the claims are used only to name the elements or to distinguish different embodiments or scopes and are not intended to limit the upper or lower limit of the number of the elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device comprising a housing, a light source module, a light valve, a projection lens, and a temperature control element, wherein
the light source module is disposed in the housing and is configured to provide an illumination beam,
the light valve is disposed on a transmission path of the illumination beam and is configured to convert the illumination beam into an image beam,
the projection lens is disposed on a transmission path of the image beam and comprises a lens barrel having a curved surface, and
the temperature control element is disposed on the projection lens and is configured to cool or heat the projection lens, wherein the temperature control element has a temperature control surface, the shape of the temperature control surface matches the curved surface of the lens barrel, and the temperature control surface is configured to be connected to the curved surface of the lens barrel.

2. The projection device of claim 1, wherein the temperature control element comprises a first substrate, a second substrate, and a plurality of semiconductor structures connected between the first substrate and the second substrate, and the first substrate is in a curved shape and is connected to the curved surface.

3. The projection device of claim 2, wherein the second substrate is in a curved shape.

4. The projection device of claim 2, wherein the second substrate is in a flat shape.

5. The projection device of claim 4, further comprising:
a heat dissipation module connected to the second substrate.

6. The projection device of claim 2, wherein the curvature of the first substrate is different from the curvature of the second substrate.

7. The projection device of claim 1, wherein the lens barrel includes a light incident portion and a light exit portion opposite to each other, and an extension portion located between the light incident portion and the light exit portion, and
length of the light incident portion, the light exit portion, or the extension portion respectively occupies one-third to two-thirds of the total length of the lens barrel.

8. The projection device of claim 7, wherein the temperature control element is connected to the light incident portion.

9. The projection device of claim 7, wherein the temperature control element is connected to the light exit portion.

10. The projection device of claim 7, wherein the temperature control element is connected to the extension portion.

11. The projection device of claim 2, further comprising:
a temperature sensing element disposed in the housing for sensing a temperature of the projection device.

12. The projection device of claim 11, wherein when the temperature of the projection device sensed by the temperature sensing element is less than or equal to 40 degrees Celsius, the temperature of the first substrate is greater than the temperature of the second substrate.

13. The projection device of claim 11, wherein when the temperature of the projection device sensed by the temperature sensing element is greater than or equal to 40 degrees Celsius, the temperature of the first substrate is less than the temperature of the second substrate.

14. The projection device of claim 1, wherein a material of the lens barrel is plastic or metal.

15. The projection device of claim 1, wherein the projection lens is a replaceable lens structure.

16. A temperature control method of a projection device, wherein the projection device comprises a projection lens, a temperature control element, and a temperature sensing element, wherein the projection lens comprises a lens barrel having a curved surface, the temperature control element has a temperature control surface, the shape of the temperature control surface matches the curved surface of the lens barrel, and the temperature control surface is configured to be connected to the curved surface of the lens barrel, and wherein the temperature control method comprises:
sensing a sensed temperature of the projection device by the temperature sensing element;
starting the temperature control element according to the sensed temperature; and
cooling or heating the projection lens of the projection device by the temperature control element.

17. The temperature control method of the projection device of claim 16, wherein the starting the temperature control element according to the sensed temperature comprises:
comparing the sensed temperature with a preset temperature; and
starting the temperature control element according to a difference between the sensed temperature and the preset temperature, so as to cool or heat the projection lens, wherein the temperature control element heats the projection lens when the sensed temperature is less than or equal to the preset temperature, and the temperature control element cools the projection lens when the sensed temperature is greater than or equal to the preset temperature.

18. The temperature control method of the projection device of claim 17, wherein the preset temperature is 40 degrees Celsius.

19. The temperature control method of the projection device of claim 17, wherein the temperature control element comprises a first substrate, a second substrate, and a plurality of semiconductor structures connected between the first substrate and the second substrate, and the first substrate is in a curved shape and is connected to the curved surface.

20. The temperature control method of the projection device of claim 19, wherein the starting the temperature control element according to the difference between the sensed temperature and the preset temperature to cool or heat the projection lens comprises:
when the temperature of the projection device sensed by the temperature sensing element is less than or equal to 40 degrees Celsius, applying a positive voltage to the plurality of semiconductor structures so that the temperature of the first substrate is greater than the temperature of the second substrate.

21. The temperature control method of the projection device of claim 19, wherein the starting the temperature control element according to the difference between the sensed temperature and the preset temperature to cool or heat the projection lens comprises:
when the temperature of the projection device sensed by the temperature sensing element is greater than or equal to 40 degrees Celsius, applying a negative voltage to the plurality of semiconductor structures so that the temperature of the first substrate is less than the temperature of the second substrate.

22. The temperature control method of the projection device of claim 17, the temperature control method further comprising:
sensing a controlled temperature of the projection device; and
changing a voltage value of the temperature control element according to the controlled temperature.
